(19) United States
(12) Patent Application Publication
(10) Pub. No.: US 2014/0180470 A1
(43) Pub. Date: Jun. 26, 2014

(54) BIN ALLOCATION METHOD OF POINT LIGHT SOURCES FOR CONSTRUCTING LIGHT SOURCE SETS

(71) Applicant: NATIONAL CHENG KUNG UNIVERSITY, Tainan City (TW)

(72) Inventors: Haw-Ching YANG, TAINAN (TW); Hung-Wei CHEN, PINGTUNG COUNTY (TW); Fan-Tien CHENG, TAINAN (TW)

(73) Assignee: NATIONAL CHENG KUNG UNIVERSITY, TAINAN CITY (TW)

(21) Appl. No.: 13/846,806

(22) Filed: Mar. 18, 2013

(30) Foreign Application Priority Data
Dec. 26, 2012 (TW) 101150173

(51) Int. Cl. G05B 11/01

(52) U.S. Cl. CPC G05B 11/01
USPC 700/225

(57) ABSTRACT

A bin allocation method of point light sources for constructing light source sets is provided. In this method, a matching matrix corresponding to each light source set product is provided for showing feasible combinations of bin codes of the point light sources which can be used for constructing the light source sets. Then, for reducing computation loading, the original matching matrix is reduced to a simplified matching matrix according to effective inventories of point light sources. Thereafter, the simplified matching matrix of each light source set product is applied to search for low exchangeable bin codes of the point tight sources among the light source set products. Then, the point light sources with the low exchangeable bin codes are precedently used for constructing the light source set products.

### RELATED APPLICATIONS

The present application is based on, and claims priority from Taiwan Application Serial Number 101150173, filed Dec. 26, 2012, the disclosure of which is hereby incorporated by reference herein in its entirety.

### BACKGROUND

1. Field of Invention

The present invention relates to a bin allocation method of point light sources for constructing light source sets. More particularly, the present invention relates to a bin allocation method for precedently using point light sources which are low exchangeable among various light source sets for constructing light source sets.

2. Description of Related Art

When a lot of light-emitting diodes (LEDs) are produced, the LEDs are different and normally distributed in their characteristics such as chromaticity, illumination and voltage. In general, for representing LED characteristics, a range of a characteristic (such as chromaticity, illumination or voltage) is divided into a plurality of zones, and then each zone is represented by a bin code. A variety of characteristic of each LED fail into respective zones, and thereby a plurality of bin codes corresponding to various characteristics are generated respectively. The LEDs with the same characteristic level will fall into the same zone, and has the same bin code. For example, in a bin code “2G41”. “2” represents the voltage characteristic; “G” represents the illumination characteristic; and “41” represents the illumination characteristic.

Since the LED is a point light source, a practical application often needs to combine several point light sources as a linear-type light source (such as a light pipe of a backlight module). As described above, since the characteristics of a lot of LEDs show normal distributions, each of the LEDs with appropriate characteristics can be used alone to form a linear-type light source, and the LEDs with complementary characteristics can be matched to form the linear-type light source. The method of using one single bin code of LED to form a linear light source is referred to as a “single bin allocation”; and the method interlacing two bin codes of LEDs to form a linear light source is referred to as a “mixed bins allocation”. Hence, each type of linear light source product has a feasible matching table used for indicating which bin codes of LEDs are suitable for the “single bin allocation”, and which bin codes of LEDs are suitable for the “mixed bins allocation”. Generally speaking, the application of “single bin allocation” has less excess-inventory problems relatively, but has to purchase the LEDs with specific specifications (bin codes) and has higher cost. Although the application of “single bin allocation” may purchase the entire lot of LEDs with widely distributed bin codes, yet because the amounts of the respective bin codes of LEDs are uneven, it is very likely to result in the problem that some bin codes of LEDs are difficult to be consumed.

When there are a lot of the types of linear light source products, the point light sources for matching (“mixed bins allocation”) will be shared or exchanged by the respective linear light source products in accordance with their different chromaticity, illumination and voltages, and thus the possible combinations of the point light sources commonly used in the feasible matching table can be up to thousands. On inventory control, since the point light sources which are highly exchangeable among the respective linear light source products are easily used, their inventories will be consumed first, thus causing the low exchangeable point light sources (referred to as “side-bins”) to be consumed difficultly. Further, due to fast falling price loss of point light sources, a challenge is how to optimize cross-site inventory of point light sources.

When performing a bin allocation of point light sources for assembling linear-type light sources (light source sets), a conventional skill has to consider the feasible matching tables of point light sources among linear-type light source products and the inventories of the point light sources, and then conduct cross-references and allocations until the required orders have been filled or no unusable inventory exists. Such a conventional skill not only consumes a lot of time, but also causes errors easily, thus affecting the delivery time of orders.

Hence, there is a need to provide a bin allocation method of point light sources for constructing light source sets to achieve the optimum inventory of point light sources by finding the bin codes of low exchangeable point light sources to be precedently (first) used for constructing the light source sets.

### SUMMARY

An object of the present invention is to provide a method for precedently using low exchangeable bin codes to reach the objectives of maximizing order fulfillment and minimizing inventories of low exchangeable bin codes with respect to point light sources, and to reduce the cost for purchasing the point light sources with designated bin codes.

According to an aspect of the present invention, a bin allocation method of point light sources for constructing light source is provided. In the bin allocation method, at first, a plurality of bin codes corresponding to a plurality of point light sources are provided, wherein characteristics of the point light sources are distributed into a plurality of zones, and the bin codes represent the characteristics of the point light sources corresponding to the zones respectively. Then, a p number of zero-one matrices are provided,

$${C}_{k}^{o} = [ \begin{matrix}{b}_{11} & … & {b}_{1 n} \\ ⋮ & {b}_{ij} & ⋮ \\ {b}_{n 1} & … & {b}_{nn}\end{matrix} ]$$

corresponding to p types of light source set products respectively, wherein 1≦k≦p;1≦i,j≦n; Cₖ^{o} represents the zero-one matrix corresponding the k^{th} type of light source set product; n represents the feasible number of the bin codes; if bᵢⱼ is 1, it means that the i^{th} bin code and the j^{th} bin code are a feasible combination for forming the k^{th} type of light source set product; and if bᵢⱼ is 0, it means that the i^{th} bin code and the j^{th} bin code are an infeasible combination for forming the k^{th} type of light source set product. Thereafter, a p number of mask matrices,

$${C}_{k}^{M} = [ \begin{matrix}{v}_{11} & … & {v}_{1 n} \\ ⋮ & {v}_{ij} & ⋮ \\ {v}_{n 1} & … & {v}_{nn}\end{matrix} ] ,$$

corresponding to p types of light source set products respectively are provided, wherein Cₖ^{M} represents the mask matrix corresponding the k^{th} type of light source set product; if inventories of the point light sources with the i^{th} bin code or the j^{th} bin code are invalid inventories, vᵢⱼ is set to 0; and if inventories of the point light sources with the i^{th} bin code and the j^{th} bin code are valid inventories, vᵢⱼ is set to 1. Then, a simplifying step is performed on each of the types of light source set products: Cₖ^{R}=Cₖ^{o}∘Cₖ^{M}, wherein the symbol “∘” is defined as a mask operation: if entries of a row and a column in Cₖ^{M} at which an element is addressed are 0 simultaneously, it represents that the point light source with a first bin code corresponding to the element does not have a valid inventory, and the row and the column corresponding to the first bin code of the element in Cₖ^{o} are deleted simultaneously, thereby obtaining a simplified matching matrix

$${C}_{k}^{R} = [ \begin{matrix}{c}_{11} & … & {c}_{1 m} \\ ⋮ & {c}_{st} & ⋮ \\ {c}_{m 1} & … & {c}_{mm}\end{matrix} ] ,$$

wherein 1≦s,t≦m; in represents the amount of the bin codes with valid inventories; m<n; and cₛₜ is corresponding to bᵢⱼ in the original Cₖ^{o}. Then, the p number of Cₖ^{R} are stacked and added to form a side-bin matching matrix

$${C}^{SB} = {\sum }_{k = 1}^{P} {C}_{k}^{R} = [ \begin{matrix}{c}_{11}^{′} & … & {c}_{1 m}^{′} \\ ⋮ & {c}_{st}^{′} & ⋮ \\ {c}_{m 1}^{′} & … & {c}_{mm}^{′}\end{matrix} ]$$

When 1≦c′ₛₜ≦η, the point light sources with the i^{th} bin code and the j^{th} bin code in the original Cₖ^{o} corresponding to c′ₛₜ are selected as a plurality of side-bin point light sources, wherein η is a threshold value. Thereafter, a zero^{th}-level allocation is performed for precedently using the side-bin point light sources to assemble the light source set products.

In one embodiment, when c′ₛₜ>η, the point light sources with the i^{th} bin code and the j^{th} bin code in the original Cₖ^{o} corresponding to c′ₛₜ are selected to assemble the light source set products. In another embodiment, a first-level allocation is first performed for using the point light sources of i≠j to assemble the light source set products, and then a second-level allocation is performed for using the point light sources of i=j to assemble the light source set products.

In one embodiment, the point light sources are a plurality of light-emitting diodes (LEDs).

In one embodiment, the at least one light source set is at least one linear-type light source, such as a light pipe of a backlight module.

Hence, the application of the embodiments of the present invention can precedently use low exchangeable bin codes effectively, thus reaching the objectives of maximizing order fulfillment and minimizing inventories of low exchangeable bin codes with respect to point light sources, and reducing the cost for purchasing the point light sources with designated bin codes.

### BRIEF DESCRIPTION OF THE DRAWINGS

These and other features, aspects, and advantages of the present invention will become better understood with regard to the following description, appended claims, and accompanying drawings where:

FIG. 1 is a flow chart showing a bin allocation method of point light sources for constructing light source according to an embodiment of the present invention.

### DESCRIPTION OF THE PREFERRED EMBODIMENTS

Reference will now be made in detail to the embodiments of the present invention, examples of which are illustrated in the accompanying drawings. Wherever possible, the same reference numbers are used in the drawings and the description to refer to the same or like parts.

Embodiments of the present invention adopts a matching matrix for showing feasible combinations of respective point light sources for constricting a light source set, wherein the matching matrix is a zero-one matrix. To reduce computation loading, embodiments of the present invention provides a mask matrix in accordance with valid inventories, thereby reducing the original matching matrix to a simplified matching matrix. Then, the simplified matching matrices of light source set products in demand are used to find feasible matching combinations of low exchangeable point light sources among the respective light source set products, and the low exchangeable point light sources are referred to as side-bin point light sources, and their feasible matching combinations form a side-bin matching matrix. In a multi-level model, at a zero^{th} level, the side-bin point light sources are precedently (first) used for assembling the light source set products; at a first level, a “mixed bins allocation” is first performed; and then the allocation result is imported to a second level for performing a “single bin allocation” with respect to unfilled orders. At this point, if the valid inventories are sufficient, most of the demands of the light source set products will be satisfied at the second level. Further, for preventing loss caused by defect rate in assembling, a final allocation will be performed with respect to the final shortages in orders.

Hereinafter, an application example is used for assisting the explanation of the flow chart according to embodiments of the present invention.

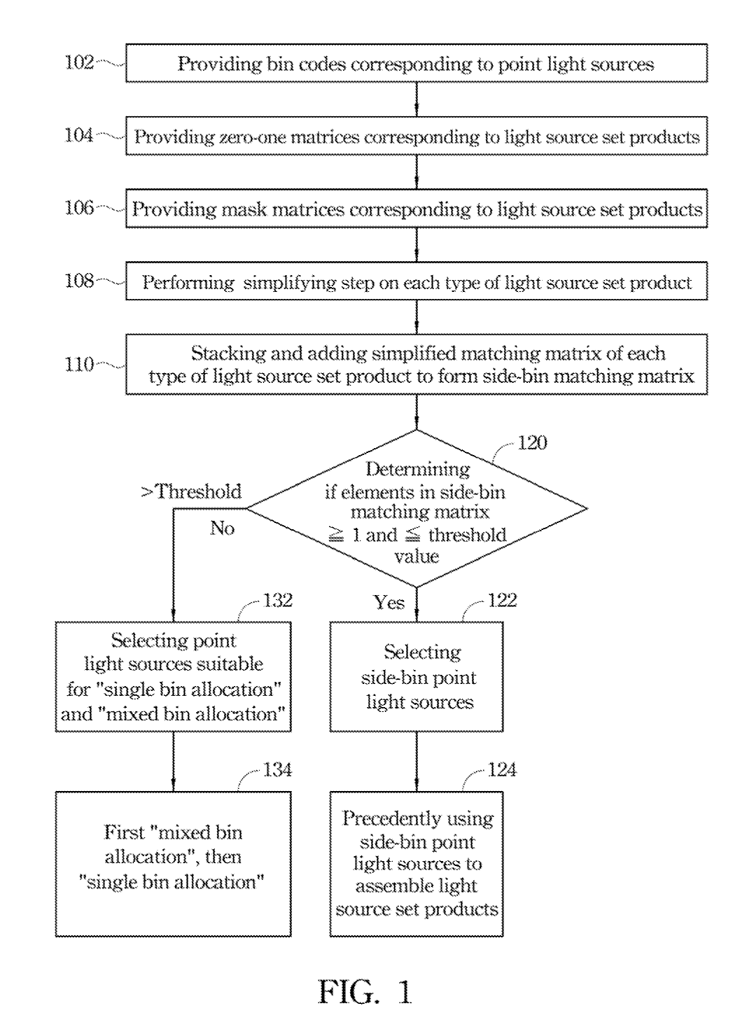

Referring to FIG. 1 FIG. 1 is a flow chart showing a bin allocation method of point light sources for constructing light source according to an embodiment of the present invention. As shown in FIG. 1, at first, a plurality of bin codes corresponding to a plurality of point light sources are provided (step 102, wherein characteristics of the point light sources are normally distributed into a plurality of zones, for example. The bin codes represent the characteristics of the point light sources corresponding to the zones respectively, and the characteristics of the point light sources may he distributed in another form of distribution. The point light sources can be such as light-emitting diodes, light bubbles, or other types of illumination elements. Then, step 104 is performed for providing a p number of zero-one matrices,

$${C}_{k}^{o} = [ \begin{matrix}{b}_{11} & … & {b}_{1 n} \\ ⋮ & {b}_{ij} & ⋮ \\ {b}_{n 1} & … & {b}_{nn}\end{matrix} ] ,$$

corresponding to p types of light source set products respectively, wherein 1≦k≦p;1≦i, j≦n; Cₖ^{o} represents the zero-one matrix corresponding the k^{th} type of light source set product; n represents the number of the bin codes; if bᵢⱼ is 1, it means that the i^{th} bin code and the j^{th} bin code are a feasible combination for forming the k^{th} type of light source set product; and if bᵢⱼ is 0, it means that the i^{th} bin code (referred to as “bin code i′ hereinafter) and the j^{th} bin code (referred to as “bin code j” hereinafter) are a feasible combination for forming the k^{th} type of light source set product (referred to as “product k” hereinafter). If bᵢⱼ≠0 and i=j, it means that the point light sources with bin code i can be allocated for constructing product k independently, which is the so-called “single bin allocation”; and if bᵢⱼ≠0 and i≠j, it means that the point light sources with bin code i and bin code j can be paired up for constructing product k, which is the so-called “mixed bin allocation”.

For example,

$${C}_{p}^{o} = [ \begin{matrix}0 & 0 & 1 & 0 & 0 \\ 0 & 1 & 0 & 1 & 1 \\ 1 & 0 & 0 & 0 & 0 \\ 0 & 1 & 0 & 0 & 0 \\ 0 & 1 & 0 & 0 & 1\end{matrix} ] ,$$

where b₂₂≠0, b₅₅≠0 represent that bin code 2 and bin code 5 can used for “single bin allocation”; and the combinations suitable for “mixed bin allocation” are b₁₃, b₃₁≠0, {bin code 1, bin code 3}; b₂₄, b₄₂≠0, i.e. {bin code 2, bin code 4}; b₂₅, b₅₂≠0, i.e. (bin code 2, bin code 5}.

Then, the original matching matrix Cₖ^{o} is reduced in accordance with the valid inventories of the respective point light sources, thereby reducing computation loading and avoid unnecessary computation time. At first, step 106 is performed for providing a p number of mask matrices,

$${C}_{k}^{M} = [ \begin{matrix}{v}_{11} & … & {v}_{1 n} \\ ⋮ & {v}_{ij} & ⋮ \\ {v}_{n 1} & … & {v}_{nn}\end{matrix} ] ,$$

corresponding to p types of light source set products respectively, wherein Cₖ^{M} represents the mask matrix corresponding light source set product k. If inventories of the point light sources with bin code i or bin code j are invalid inventories, vᵢⱼ is set to 0; and if inventories of the point light sources with bin code i and bin code j are valid inventories, vᵢⱼ is set to 1.

For example,

$${C}_{k}^{M} = [ \begin{matrix}0 & 0 & 0 & 0 & 0 \\ 0 & 1 & 1 & 1 & 1 \\ 0 & 1 & 1 & 1 & 1 \\ 0 & 1 & 1 & 1 & 1 \\ 0 & 1 & 1 & 1 & 1\end{matrix} ] ,$$

where v₁ⱼ=0 represents that the inventory of the point light sources with bin code 1 is an invalid inventory, and the inventories of the point light sources with bin code 2, bin code 3, bin code 4, bin code 5 are valid inventories.

Thereafter, a simplifying step 108 is performed on each of the types of light source set products: Cₖ^{R}=Cₖ^{o}∘Cₖ^{M}, wherein the symbol “∘” is defined as a mask operation. The rules of the mask operation are shown in the below.

According to valid inventories, if entries of a row and a column in Cₖ^{M} are 0 simultaneously, it represents that the point light source with the bin code corresponding to the row and the column does not have a valid inventory, and the row and the column corresponding to the bin code should be deleted simultaneously. In other words, if entries of a row and a column in Cₖ^{M} at which any element is addressed are 0 simultaneously, it represents that the point light source with a bin code corresponding to the element does not have a valid inventory, and the row and the column corresponding to the first bin code of the element in Cₖ^{o} are deleted simultaneously, thereby obtaining a simplified matching matrix:

$${C}_{k}^{R} = [ \begin{matrix}{c}_{i 1} & … & {c}_{1 m} \\ ⋮ & {c}_{st} & ⋮ \\ {c}_{m 1} & … & {c}_{mm}\end{matrix} ] ,$$

wherein 1≦s,t≦m; m represents the amount of the bin codes with valid inventories; m<n; and cₛₜ is corresponding to bᵢⱼ in the original Cₖ^{o}.

For example, a simplifying step 108 is performed by using the mask matrix ad the matching matrix shown in the previous example, and its mask operation is performed as follows.

$$[ \begin{matrix}0 & 0 & 1 & 0 & 0 \\ 0 & 1 & 0 & 1 & 1 \\ 1 & 0 & 0 & 0 & 0 \\ 0 & 1 & 0 & 0 & 0 \\ 0 & 1 & 0 & 0 & 1\end{matrix} ] ∘ [ \begin{matrix}0 & 0 & 0 & 0 & 0 \\ 0 & 1 & 1 & 1 & 1 \\ 0 & 1 & 1 & 1 & 1 \\ 0 & 1 & 1 & 1 & 1 \\ 0 & 1 & 1 & 1 & 1\end{matrix} ] = [ \begin{matrix}0 & 0 & 0 & 0 & 0 \\ 0 & 1 & 0 & 1 & 1 \\ 0 & 0 & 0 & 0 & 0 \\ 0 & 1 & 0 & 0 & 0 \\ 0 & 1 & 0 & 0 & 1\end{matrix} ]$$

Then, the entire row and column in the resulted matrix at which entries are o at the same time are deleted to obtain a simplified matching matrix.

$${C}_{k}^{R} = [ \begin{matrix}1 & 1 & 1 \\ 1 & 0 & 0 \\ 1 & 0 & 1\end{matrix} ]$$

There are three bin codes left for the combination rules reserved in the simplified matching matrix, and the corresponding bin codes should be referred back to the original matching matrix Cₖ^{o}. For example, bin code 1 in the simplified matching matrix Cₖ^{R} is corresponding to bin code 2 in the original matching matrix Cₖ^{o}; bin code 2 in the simplified matching matrix Cₖ^{R} is corresponding to bin code 4 in the original matching matrix Cₖ^{o}; and bin code 3 in the simplified matching matrix Cₖ^{R} is corresponding to bin code 5 in the original matching matrix Cₖ^{o}.

Hereinafter, steps are performed for selecting low exchanged point light sources (sided-bins).

At first, step 110 is performed for stacking and adding the simplified matching matrix Cₖ^{R} of each type of light source set product having a daily demand to form a side-bin matching matrix

$${C}^{SB} = {\sum }_{k = 1}^{P} {c}_{k}^{R} = [ \begin{matrix}{c}_{11}^{′} & … & {c}_{1 m}^{′} \\ ⋮ & {c}_{st}^{′} & ⋮ \\ {c}_{m 1}^{′} & … & {c}_{mm}^{′}\end{matrix} ] .$$

Then, step 120 is performed for determining if elements in the side-bin matching matrix C^{SB} are greater than or equal to 1 and are smaller than or equal to a threshold value η, i.e. if 1≦c′_{M}≦η. When the result of step 120 is yes (1≦c′ₛₜ≦η), the point light sources with bin code i and bin code j in the original Cₖ^{o} corresponding to c′ₛₜ are selected as a plurality of side-bin point light sources (step 122). Since the side-bin point light sources are lowly exchangeable among the types of light source set products, the number of varieties of point light sources in stock can be decreased if the side-bin point light sources can be used up as soon as possible. Hence, step 124 is performed for precedently (first) using the side-bin point light sources to assemble the light source set products.

On the other hand, when the result of step 120 is no (c′ₛₜ>η), the point light sources with the i^{th} bin code and the j^{th} bin code in the original Cₖ^{o} corresponding to c′ₛₜ are selected to assemble the light source set products, wherein the point light sources are suitable for “single bin allocation” and “mixed bin allocation” (step 132). In another embodiment, step 134 is performed for first using the point light sources of i≠j to assemble the light source set products (“mixed bin allocation”), and then using the point light sources of i=j to assemble the light source set products (“single bin allocation”).

For example, let say there are three types of light source set products in demands (p=3), and their respective simplified matching matrices are:

$${C}_{1}^{R} = [ \begin{matrix}1 & 0 & 0 \\ 0 & 0 & 1 \\ 0 & 1 & 1\end{matrix} ] ; {C}_{2}^{R} = [ \begin{matrix}0 & 0 & 1 \\ 0 & 0 & 1 \\ 1 & 1 & 1\end{matrix} ] ; {C}_{3}^{R} = [ \begin{matrix}0 & 1 & 1 \\ 1 & 0 & 0 \\ 1 & 0 & 1\end{matrix} ] ,$$

At first,step 110 is performed to stack and add all of the simplified matching matrices:

$${\sum }_{k = 1}^{3} {C}_{k}^{R} = [ \begin{matrix}1 & 1 & 2 \\ 1 & 0 & 2 \\ 2 & 2 & 3\end{matrix} ] .$$

When 1≦c′ₛₜ≦η (set η to 1), the point light source with bin code 2 and bin code 4 in the original Cₖ^{o} corresponding to c′ₛₜ are side-bin point light source, wherein bin code 2 can be used for “single bin allocation”; bin code 2 and bin code 4 can be used for “mixed bin allocation”. When c′ₛₜ>η, the point light source with bin code 2, bin code 4 and bin code 5 in the original Cₖ^{o} corresponding to c′ₛₜ can be selected for constructing the light source set products, wherein bin code 5 can be used for “single bin allocation”; {bin code 4, bin code 5} and {bin code 2, bin code 5} can be used for “mixed bin allocation”. In one embodiment, the point light sources with {bin code 4, bin code 5} and {bin code 2, bin code 5} are first used for constructing the light source set products, and then the point light sources with bin code 5 are for constructing the light source set products.

In a multi-level model used in the embodiment of the present invention, at a zero^{th} level, {bin code 2, bin code 2} or {bin code 2, bin code 4} are precedently (first) used for assembling the light source set products; at a first level, a “mixed bins allocation” with {bin code 4, bin code 5} or {bin code 2, bin code 5} is first performed; and then at a second level, “single bin allocation” with {bin code 5, bin code 5} is performed with respect to unfilled orders. At this point, if the valid inventories are sufficient, most of the demands of the light source set products will be satisfied at the second level. Further, for preventing loss caused by defect rate in assembling, a final allocation can be performed with respect to the final shortages in orders.

The aforementioned embodiments can be provided as a computer program product stored on a non-transitory tangible computer readable recording medium on which instructions are stored for programming a computer or other electronic devices) to perform a process based on the embodiments of the present invention. The machine-readable medium can be, but is not limited to, a floppy diskette, an optical disk, a compact disk-read-only memory (CD-ROM), a magneto-optical disk, a read-only memory (ROM), a random access memory (RAM), an erasable programmable read-only memory (EPROM), an electrically erasable programmable read-only memory (EEPROM), a magnetic or optical card, a flash memory, or another type of media/machine-readable medium suitable for storing electronic instructions. Moreover, the embodiments of the present invention also can be downloaded as a computer program product, which may be transferred from a remote computer to a requesting computer by using data signals via a communication link (such as a network connection or the like).

It can be known from the above that, with the application of the embodiments of the present invention, the point light sources with low exchangeable bin codes (side-bins) can be precedently used effectively, thus reaching the objectives of maximizing order fulfillment and minimizing inventories with respect to point light sources, and lowering the cost for purchasing the point light sources with designated bin codes.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A bin allocation method of point light sources for constructing light source, the bin allocation method comprising:
providing a plurality of bin codes corresponding to a plurality of point light sources, wherein characteristics of the point light sources are distributed into a plurality of zones, and the bin codes represent the characteristics of the point light sources corresponding to the zones respectively;
providing a p number of zero-one matrices,
$${C}_{k}^{o} = [ \begin{matrix}{b}_{11} & … & {b}_{1 n} \\ ⋮ & {b}_{ij} & ⋮ \\ {b}_{n 1} & … & {b}_{nn}\end{matrix} ] ,$$
corresponding to p types of light source set products respectively, wherein 1≦k≦p;1≦i,j≦n; Cₖ^{o} represents the zero-one matrix corresponding the k^{th} type of light source set product; a represents the number of the bin codes; if bᵢⱼ is 1, it means that the i^{th} bin code and the j^{th} bin code are a feasible combination for forming the k^{th} type of light source set product; and if bᵢⱼ is 0, it means that the i^{th} bin code and the j^{th} bin code are an infeasible combination for forming the k^{th} type of light source set product;
providing a p number of mask matrices,
$${C}_{k}^{M} = [ \begin{matrix}{v}_{11} & … & {v}_{1 n} \\ ⋮ & {v}_{ij} & ⋮ \\ {v}_{n 1} & … & {v}_{nn}\end{matrix} ]$$
corresponding to p types of light source set products respectively, wherein Cₖ^{M} represents the mask matrix corresponding the k^{th} type of light source set product; if inventories of the point light sources with the i^{th} bin code or the j^{th} bin code are invalid inventories, vᵢⱼ is set to 0; and if inventories of the point light sources with the i^{th} bin code and the j^{th} bin code are valid inventories, vᵢⱼ is set to 1:
performing a simplifying step on each of the types of light source set products: Cₖ^{R}=Cₖ^{o}∘Cₖ^{M}, wherein the symbol “∘” is defined as a mask operation: if entries of a row and a column in Cₖ^{M} at which an element is addressed are 0 simultaneously, it represents that the point light source with a first bin code corresponding to the element does not have a valid inventory, and the row and the column corresponding to the first bin code of the element in Cₖ^{o} are deleted simultaneously, thereby obtaining a simplified matching matrix
$${C}_{k}^{R} = [ \begin{matrix}{c}_{11} & … & {c}_{1 m} \\ ⋮ & {c}_{st} & ⋮ \\ {c}_{m 1} & … & {c}_{mm}\end{matrix} ] ,$$
wherein 1≦s,t≦m; m represents the amount of the bin codes with valid inventories; m<n; and cₛₜ is corresponding to bᵢⱼ in the original Cₖ^{o};
stacking and adding the p number of Cₖ^{R} to form a side-bin matching matrix
$${C}^{SB} = {\sum }_{k = 1}^{P} {C}_{k}^{R} = [ \begin{matrix}{c}_{11}^{′} & … & {c}_{1 m}^{′} \\ ⋮ & {c}_{st}^{′} & ⋮ \\ {c}_{m 1}^{′} & … & {c}_{mm}^{′}\end{matrix} ] ;$$
when 1≦c′ₛₜ≦η, selecting the point light sources with the i^{th} bin code and the j^{th} bin code in the original Cₖ^{o} corresponding to c′ₛₜ as a plurality of side-bin point light sources, wherein is a threshold value; and
performing a zero^{th}-level allocation for precedently using the side-bin point light sources to assemble the light source set products.

2. The bin allocation method as claimed in claim 1, further comprising:
when c′ₛₜ>η, selecting the point light sources with the i^{th} bin code and the j^{th} bin code in the original Cₖ^{o} corresponding to c′ₛₜ to assemble the light source set products,

3. The bin allocation method as claimed in claim 2, wherein a first-level allocation is first performed for using the point light sources of i≠j to assemble the light source set products, and then a second-level allocation is performed for using the point light sources of i=j to assemble the light source set products.

4. The bin allocation method as claimed in claim 1, wherein the point light sources are a plurality of light-emitting diodes (LEDs),

5. The bin allocation method as claimed in claim 1, wherein the at least one light source set is at least one linear-type light source.
